(19) United States
(12) Patent Application Publication
(10) Pub. No.: US 2009/0018027 A1
(43) Pub. Date: Jan. 15, 2009

(54) Method for Producing Chemical Microarrays

(75) Inventors: Frank Ronald, Meine (DE); Ulrike Beutling, Braunschweig (DE); Andrzej Swistowski, Braunschweig (DE); Antonius Dikmans, Braunschweig (DE); Varsha Gupte, Braunschweig (DE); Sabine Thiele, Braunschweig (DE)

Correspondence Address: EDWARDS ANGELL PALMER & DODGE LLP, P.O. BOX 55874, BOSTON, MA, 02205, US

(73) Assignee: GESELLSCHAFT FUER BIOTECHNOLOGISCHE FORSCHUNG MBH, Braunschweig (DE)

(21) Appl. No.: 11/596,604

(22) PCT Filed: May 12, 2005
(86) PCT No.: PCT/EP05/05189

§ 371 Date: May 7, 2008

(30) Foreign Application Priority Data
May 13, 2004 (DE) 10 2004 023 906.1

(51) Int. Cl. C40B 30/04; C40B 50/18; C40B 40/04

(52) U.S. Cl. 506/9; 506/32; 506/15

(57) ABSTRACT

A method of producing a microarray, the microarray itself and the use of the microarray for detecting interactions between probe molecules and analyte molecules from a sample is provided. The method comprises the steps of synthesis, in two or more stages, of probe molecules on a polymeric support, bonds being formed between the probe molecules and the polymeric support; dispersion of the polymeric support having the synthetic probe molecules,

the bonds between the polymeric support and the probe molecules being retained; optional purification of the probe molecules bound to the polymeric support; dissolution of the polymeric support having the bound probe molecules; and application of the solution containing the polymeric support having the bound probe molecules in the form of microdrops to a planar surface.

### BACKGROUND TO THE INVENTION

The present invention relates to a method of producing a microarray, to a microarray for detecting interactions between probe molecules and analyte molecules from a sample and to the use of the microarray for such detection.

In scientific parlance, collections of a large number of different test compounds arranged on a flat surface are referred to as “arrays”. The test compounds are often also referred to as probes or probe molecules, which are bound or immobilised on the flat surface. Such arrays allow rapid, simultaneous testing of all probe molecules in respect of their interaction with an analyte or mixture of analytes in a sample. The analytes of the sample are often referred to as (target) molecules. The advantage of a planar array over a test (assay) having immobilised probe molecules on mobile elements, such as, for example, beads, is that in an array the chemical structure and/or the identity of the immobilised probe molecules is precisely defined by their location in the array surface. A specific local test signal, which is produced, for example, by an interaction between the probe molecule and the analyte molecule, can accordingly be immediately assigned to a type of molecule or to a probe molecule. As evidence of an interaction between a probe molecule and an analyte molecule it is also possible to use the enzymatic conversion of the probe by the biomolecule, with the result that a local test signal can also disappear and accordingly serves as direct evidence. Particularly in miniaturised form, arrays having biological probe molecules are also known as biochips.

Examples of such arrays in the prior art are nucleic acid arrays of DNA fragments, cDNAs, RNAs, PCR products, plasmids, bacteriophages and synthetic PNA oligomers, which are selected by means of hybridisation, with formation of a double-strand molecule, to give complementary nucleic acid analytes. In addition, protein arrays of antibodies, proteins expressed in cells or phage fusion proteins (phage display) play an important part. Furthermore, compound arrays of synthetic e: peptides, analogues thereof, such as peptoids, oligocarbamates or generally organic chemical compounds, are known, which are selected, for example, by means of binding to affinitive protein analytes or other analytes by means of enzymatic reaction. Moreover, arrays of chimaeras and conjugates of the said probe molecules have been described.

Such arrays are currently produced in accordance with two different principles by applying the probe molecules to the surfaces of materials that have been specially prepared beforehand, for example chip surfaces. An overview in this connection is given by Wölfl in: Transcript Laborwelt 3 (2000), 13-20.

The two different principles relate firstly to a single-step application of solutions of pre-prepared probe molecules on the surface and/or secondly to repeated, serial application of solutions of building blocks for the parallel chemical synthesis of the probe molecules in situ on the surface.

The surface having the bound probe molecules is then brought into contact, over its entire area, with the solution of the analyte molecules from a sample, so that when the specific and selective interaction between the probe molecule and an analyte molecule is complete, a signal is generated at the location of the probe molecule. That signal can either be produced directly, for example by binding of a fluoresence-labelled biomolecule, or can be generated in further treatments with detection reagents, for example in the form of an optical or radioactive signal. After excess analyte molecules have been washed out, the signal is read out. The many different technical details relating to procedure and detection are described in Bowtell & Sambrook, DNA Microarrays: A cloning manual. Cold Spring Harbor Laboratory Press, Cold Spring Harbor, N.Y., (2003), ISBN 0-87969-624-9.

The increasing miniaturisation of arrays to form microarrays has great advantages especially for the analysis of biological samples, for example in medical diagnostics. For example, the more probe molecules there can be arranged per unit surface area, the more test signals (results) are obtained with the same amount of biological sample. Because in certain cases, such as, for example, in human biopsies, only a very small amount of starting material is available, it is only by such miniaturisation that diagnostic analyses can be carried out within a broad scope and the underlying queries answered.

The technologies for preparing microarrays and biochips with probe densities of more than 100 probes per cm² usually use planar non-porous glass supports as the surface, the probes being applied in the form of an almost monomolecular layer (Southern et al., Nature Genetics Suppl. No. 1 (1999), 5-9; Xu et al., Molecular Diversity, (2004), 1-10). The most important requirements for successful, sensitive detection of the analyte molecules are high selectivity of the binding events as well as high complex stability and affinity between the probe molecule and the analyte molecule. In the case of the latter, in particular a low dissociation constant k_{off} is a decisive factor which determines how quickly the resulting complex decomposes again. Only when the dissociation constant is low enough does the analyte molecule, after capture, remain for a sufficient length of time at the location of the probe molecule when the excess solutions are washed off.

Such advantageous binding conditions can almost always be achieved in the case of nucleic acids the detection of which is effected by means of hybridisation to form nucleic acid strands. When the complementary strands are sufficiently long, extremely high stabilities and selectivities are obtained. That advantageous situation tends to be rare for other probe molecules, such as, for example, peptides, oligosaccharides or chemical compounds in general, and their complexes with analyte molecules, such as, for example, proteins. The analytical problems under investigation include a wide range of complex stabilities, with dissociation constants from pM, such as, for example, streptavidin with biotin, up to mM for protein/active ingredient interactions.

For microarray analyses with complexes of low stability it has been proposed to increase the local concentration of the probe molecules. As a result, target molecules dissociated during the washing process can more quickly bind again to other probe molecules in the spatial vicinity (“re-binding”) . A significant increase in the local probe concentration is, however, obtained only when a 3D layer is used instead of a 2D planar molecular layer. Examples thereof are the use of porous layers in which the inner surface can also be utilised.

Examples thereof from practice are the SPOT synthesis on membranes of cellulose, polypropylene or Teflon (The SPOT-Synthesis Technique: Synthetic Peptide Arrays on Membrane Supports. In: Methods of parallel peptide synthesis and their contributions to deciphering molecular interactions in the immune system. Guest Editor: C. Granier, Part 3, The SPOT method of peptide synthesis: the role of arrayed peptides in revealing key features of antigen-antibody recognition. Special Issue of the Journal of Immunological Methods; Frank, J. Immunol. Meth. 267 (2002), 13-26). Protein/peptide complexes on such membrane supports can still be detected up to a dissociation constant of almost 1 mM (Hoffmüller et al., Angew. Chem. Int. Ed. 38 (1999) 2000-2003).

Further examples are the so-called patch arrays with extremely small pads or raised portions of polyacrylamide which is present covalently bonded to glass (Yershov et al., PNAS 93 (1996), 4913-4918). Alternatively, it is also possible to use small, spatially separate, graft-type polymerisations on polypropylene (DE 103 40 429). Pixel arrays having extremely small raised portions of polyacrylic acid graft on poly-propylene have also been described (WO 02/066984).

Furthermore, nitrocellulose or nylon layers that are bonded to glass supports are commercially available from Schleicher & Schüll, Germany, the recommended application density or spot density being 100 spots per cm². This cannot be miniaturised much further because of the high absorption power of the layer and on account of diffusion of the applied probe molecules.

Furthermore, planar materials having pores aligned in parallel, which are also referred to as flow-through chips, have been described (Benoit et al., Anal. Chem. 73 (2001), 2412-2420).

Furthermore, it has been described that probe molecules can first be coupled to a soluble polymeric support, such as, for example, proteins or polysaccharides, the resulting soluble conjugate then being spotted onto, for example, glass or plastics surfaces using a microfeeder. With a suitable choice of support, the dried conjugate will form a porous precipitate which, however, adheres firmly to the surface of the chip. A local situation similar to a porous membrane layer is thus created (Xu et al., Molecular Diversity, (2004), 1-10, submitted for publication). For that process, however, the probe molecules have to be present or produced in a form allowing specific linkage to the support material. In this connection, the authors propose chemical ligation between a special, ketone-modified polymeric support and amino-oxyl-acetyl-modified probes. A disadvantage, however, is especially that both components are produced separately and are combined only in a subsequent linkage step. Moreover, this must be carried out safely and reliably for many thousands of probes.

In all of the methods of producing microarrays described in the prior art, it is especially probe molecules having a low molecular weight, such as, for example, peptides or small organic molecules, that are problematic. They must be produced laboriously by combinatorial or parallel chemical synthesis, which is carried out predominantly on the surface of a polymeric support. An overview of the chemical solid phase synthesis in accordance with Merrifield and its many modifications, especially for the combinatorial and parallel production of compound libraries, is described by Dörwald, Organic Synthesis on Solid Phase, (2000) Wiley-VCH Verlag GmbH, Weinheim, Germany, ISBN 3-527-29950-5.

The present invention is therefore based on the problem of providing a novel method of producing microarrays for chemical-synthetic probe molecules, which is simpler to carry out, is able to utilise all the advantages of solid phase synthesis, including automation of the procedure, and furthermore is suitable for probe molecules having a low molecular weight.

### SUMMARY OF THE INVENTION

That problem is solved by a method of producing a microarray, the method comprising the following steps:

(a) synthesis, in two or more stages, of probe molecules on a polymeric support, bonds being formed between the probe molecules and the polymeric support;

(b) dispersion of the polymeric support having the synthetic probe molecules in accordance with step (a), the bonds between the polymeric support and the probe molecules being retained;

(c) optional purification of the probe molecules bound to the polymeric support;

(d) dissolution of the polymeric support having the bound probe molecules; and

(e) application of the solution containing the polymeric support having the bound probe molecules in the form of microdrops to a planar surface.

The method according to the invention therefore combines a series of operating steps of the prior art; in particular it combines the chemical synthesis and the conjugation, for example according to Xu et al., in Molecular Diversity, (2004), 1-10, using the same polymeric support material for both steps. A substantial simplification of the prior art is achieved as a result.

The problem is solved also by a microarray which can be produced in accordance with the method of the invention as well as by the use of the microarray for the detection of interactions between probe molecules and analyte molecules from a sample.

The method according to the invention uses parallel and combinatorial synthesis methods for producing probe molecules and molecule libraries. By the selection of a suitable polymeric support it is possible to produce directly microarrays for interaction analysis the quality and also the sensitivity of which is equivalent to previously described macro-test methods. For that method it is likewise possible to use any chemical compounds employed in macro-test methods. The particular advantage of the method according to the invention is that a large number of identical copies of microarrays can be produced or printed from a very small synthesis set. Because the same solution is used for each copy, the array copies are of very comparable quality. This is a significant difference from arrays produced by in situ synthesis, for example, in which the probe molecules have to be synthesised separately in each copy. Taking as a basis the values for the dispersion of the precipitated polymeric support that are described in the Examples section and preferred in the specific embodiments of the invention, it is possible for up to 10 million arrays, each of the same quality, to be produced from a synthesis of about 50 nmol per probe on the spots of a cellulose membrane.

In comparison with the previously described microarrays of synthetic probe molecules that are produced by mere mobilisation of the probe molecules after the synthesis (Xu et al., (2004)), the method according to the invention has a further advantage for the production especially of microarrays from small organic molecules for the search for pharmaceutical active ingredients. In addition to the chemical function of the probe molecule for anchoring on the synthesis support, no additional chemical function in the molecule is required for conjugation, which significantly increases the scope for diversity of small organic molecules.

### DESCRIPTION OF THE FIGURES

FIG. 1 shows the results of the synthesis and an antibody binding test of a collection of 125 peptide probes in accordance with the SPOT synthesis method on a cellulose membrane having a 5 mm spot spacing;

FIG. 1a shows an image of the MTT/BCIP test signals;

FIG. 1b shows the quantitative evaluation of the test signals and their representation in the form of a 2D map.

FIG. 2 shows an antibody binding test of the same probe peptides as in FIG. 1, which were produced in accordance with the SPOT synthesis method on a dissolvable cellulose membrane, after punching out, dispersion and spotting onto an untreated glass microscope slide, the SPOT spacing being 0.5 mm.

FIG. 2a shows an image of the Cy5 fluoresence test signals;

FIG. 2b shows the quantitative evaluation of the test signals and their representation in the form of a 2D map.

### DETAILED DESCRIPTION OF THE INVENTION

For the method according to the invention, the probe molecules are produced by combinatorial or parallel chemical synthesis on a suitable polymeric support and remain immobilised thereon by the selection of a stable, chemical bond, which can be especially in the form of a stable chemical anchor, for example in Frank and Overwin, In: Methods in Molecular Biology, 66: Epitope Mapping Protocols (G. E. Morris, Ed.), The Humana Press Inc., Totowa, USA (1996), 149-169). Removal of all protecting groups is possible and pre-purification of the probe molecules by washing is advisable. In that way, all the advantages of solid phase synthesis, including automation of the procedure, can be utilised. If desired, a small portion of the probe molecules can be removed from the support material in order to check the synthesis quality with the aid of analytical techniques. For such removal, a suitable linker must be provided; see, for example, Frank and Overwen, loc. cit. The support material loaded with the probe molecules is then dispersed in a solvent by a special chemical treatment which can optionally be assisted by partial degradation of the polymer. The probe molecules themselves as well as the chemical linkage of the probe molecules to the support material are retained during those steps, however. The resulting solutions of the probe molecules bound to the support material can then, if desired, be diluted and spotted using a microfeeder onto glass or plastics surfaces, for example. The microdrops are dried on the surface. The resulting microarrays having the immobilised probe molecules are then used for the interaction analysis of analyte molecules.

The polymeric support material used in the method according to the invention should be insoluble in most organic solvents that are used for chemical synthesis. It should also be inert towards most chemical synthesis reactions that are employed for the chemical synthesis of the probe molecules. Sufficiently high loading with chemical functionalities for introduction of anchor/linker compounds used for the synthesis of the chemical probes is also advantageous. Furthermore, the polymeric support material should be capable of being rendered soluble in a solvent suitable for microspotting by a process that is not destructive to the probe molecule. The polymeric support material should also allow the formation of a precipitate capable of good adhesion to glass or plastics surfaces.

The formation of a precipitate that is not dissolvable under the conditions of the interaction analysis is a crucial advantage or indispensable. Furthermore, the formation of a porous precipitate that ensures that the target or analyte molecules in the samples have sufficiently good access to the immobilised probe molecules has been found to be especially advantageous.

It has especially proved to be advantageous for the bonds between the probe molecules and the polymeric support to be chemical bonds, especially covalent chemical bonds. Covalent bonds are very strong chemical bonds which allow a long-lasting, stable bond between the probe molecules and the polymeric support even during the dispersion of the polymeric support.

The polymeric support is preferably formed from a porous material. Paper, especially cellulose paper, is particularly suitable; see, for example, Frank, Nucleic Acids Res. 11 (1983), 4365-4377; Frank and Döring, Tetrahedron 44, 19 (1988), 6031-6040; Frank, Tetrahedron 48 (1992), 9217-9232; Dittrich et al., Bioorg. Med. Chem. Lett. 8 (1998), 2351-2356.

The dispersion of the polymeric support is effected, for example, in a mixture of trifluoroacetic acid (TFA), dichloro-methane, tri-isobutylsilane (TIBS) and water. At the same time, that solution can be used to remove the side chain protecting groups still present on the probe molecules, which may be, for example, peptide probes, so that only the unprotected probe molecule or peptide is present bound to the dispersed polymeric support material.

In an especially preferred embodiment of the invention, the mixture for dispersion of the polymeric support contains about 60-100% by vol. and especially 80-90% by vol., trifluoroacetic acid, preferably about 85% by vol., about 0-15% by vol. and especially 5-15% by vol., dichloromethane, preferably about 7% by vol., about 0-5% by vol. and especially 2-5% by vol., tri-isobutylsilane, preferably about 3% by vol., and about 0-5% by vol. and especially 2-5% by vol. water, preferably about 5% by vol.

It has been found to be advantageous for the reaction time for dispersion of the polymeric support to be about 0.1-24 hours and especially 2-24 hours, preferably about 16 hours.

Washing the polymeric support having the bound probe molecules can preferably be effected in diethyl ether, acetone or tert-butylmethyl ether. Diethyl ether is especially preferred. Overall, any precipitating agent in which the polymeric support is insoluble is suitable. The impurities and removed protecting groups, however, should be readily soluble in the precipitating agent/solvent. Washing from three to five times has proved to be suitable, but washing three times is generally sufficient.

The dissolution of the polymeric support material having the probe molecules immobilised thereon is effected, for example, in water, DMF, NMP or DMSO, preference being given to DMSO. Any solvent in which the polymeric support and the probe molecules are readily soluble is suitable. Furthermore, the solvent must be suitable for the subsequent microspotting step. In the case of DMSO it has been found that it has the greatest solubilising effect and, despite its very high boiling point, is very suitable for microspotting. The amount of solvent used is especially dependent upon the polymeric support used. The dilution factor is from 1:5 to 1:100, preferably 1:20. The dilution factor is dependent upon the polymeric support used and determines the desired spot morphology on the planar surface.

In a preferred embodiment, the probe molecules are short-chain peptides, polypeptides, polysaccharides or nucleic acids, DNA molecules or RNA molecules and especially small organic molecules.

According to the invention, a microchip, especially a biochip, is obtained when the solution containing the polymeric support material having the immobilised probe molecules is spotted onto a planar surface.

Because the method according to the invention does not require any chemical or physical pre-treatment of the planar surface, any conceivable material can be used as the surface. It has proved particularly advantageous to use metal, glass, plastics material or ceramics, especially a glass microscope slide. Of course, other surfaces are also conceivable.

Alternatively, it is also possible to use as polymeric support a protein onto which probe molecules are synthesised (Hansen et al., Int. J. Peptide Protein Res. 41 (1993), 237-245). The probe molecules are synthesised in parallel in separate reaction vessels and the support material is separated from the reaction mixture by precipitation and centrifugation after each synthesis step. The further steps of the probe synthesis and microarray production are carried out in the same way as when cellulose is used as polymeric support.

As a further possible support material, in addition to cellulose or proteins, for example disulfide-crosslinked polyacrylate also comes into consideration (Goddard et al., J. Chem. Soc. Chem. Commun. (1988), 1025-1027).

The present invention relates also to a microarray for detecting interactions between probe molecules and analyte molecules from a sample, the microarray being producible by the method according to the invention.

In such a microarray, the probe molecules are preferably short-chain peptides, polypeptides, polysaccharides or nucleic acids, DNA molecules or RNA molecules, especially small organic molecules.

A sample in the context of the method includes any kind of solution of analyte molecules that can enter into an interaction or a chemical or enzymatic reaction with the probe molecules on the array. These include especially biological samples obtained by the removal of biological fluids such as blood, serum, secretions, lymph, dialysate, liquor, sap, body fluid from insects, worms, maggots, etc. Also included is extraction from natural sources such as biopsies, animal and plant organs or parts, cell, insect, worm, bacteria, microbe and parasitic matter as well as supernatants of cell cultures and of bacterial, microbial or parasitic cultures. A sample may also be a chemical-synthetic sample containing, for example, oligonucleotides, PNAs, RNAs, peptides and synthetic proteins, organically synthetic receptors, reagents and/or cage molecules.

In particular, the sample used can be a human sample and preferably a sample from a human biopsy.

The invention relates also to the use of the microarray producible by the method according to the invention for detecting interactions between probe molecules and analyte molecules from a sample.

The method according to the invention is described hereinbelow using the example of synthetic peptides as probe molecules. The chemical synthesis thereof on cellulose paper as the polymeric support in accordance with the filter method, the spot method or the cut & combine method, the dispersion of the polymeric support segments having the immobilised probes by means of trifluoroacetic acid (TFA), the purification of the immobilised probes by precipitation in ether as well as the dissolution of the precipitate in dimethyl sulfoxide (DMSO) and the spotting of the DMSO solutions onto glass supports is described. After the drying and the incubation of the spotted glass arrays with the solution of an antibody, antibodies bound to individual probe molecules can be detected using a fluorescence-labelled, secondary antibody in accordance with the ELISA principle.

Commonly used molecular-biological working methods are not described in detail here, but they can be referred to in Bowtell and Sambrook, In: DNA Microarrays: A cloning manual. Cold Spring Harbor Laboratory Press, Cold Spring Harbor, N.Y., (2003), ISBN 0-87969-624-9; Frank and Overwin, In: Methods in Molecular Biology, 66: Epitope Mapping Protocols (G. E. Morris, Ed.), The Humana Press Inc., Totowa, USA (1996), 149-169; Harlow and Lane, In: Antibodies: A laboratory manual. Cold Spring Harbor, N.Y., (1988); and Sambrook et al., Molecular Cloning: A laboratory manual. Cold Spring Harbor, N.Y. (1989), ISBN 0-87969-309-6.

### EXAMPLE

### Step 1: Synthesis of the Probe Molecules on the Polymeric Support

120 peptides were synthesised in accordance with the SPOT method (Frank, 1992). Starting from the sequence Ac-NYGKYE- of the epitope peptide for the monoclonal anti-TTL-antibody 1D3, those 120 peptides represent a complete substitution set. The monoclonal anti-TTL-antibody 1D3 is described by Erck et al., Neurochem. Res. 25 (2000), 5-10. Each amino acid of the sequence was replaced by every other of the 20 proteinogenic amino acids. The list of 120 synthesised peptides is given below.

A sheet of cellulose membrane (Whatman 540) was esterified with β-alanine. The method for this is described in Frank and Overwin, In: Methods in Molecular Biology, 66: Epitope Mapping Protocols (G. E. Morris, Ed.), The Humana Press Inc., Totowa, USA (1996), 149-169. The resulting loading after β-alanine esterification was 1.05 μmol/cm². The subsequent stepwise peptide synthesis for the synthesis of the probe molecules followed the method described by Frank and Overwin (see above). For the synthesis, the fully automatic MultiPep synthesis robot from Intavis Bioanalytische Instrumente AG in Cologne, Germany, was used in accordance with the manufacturer's directions.

After coupling of the last amino acid, the N-terminal Fmoc protecting group was removed with a 20% piperidine solution in dimethylformamide (DMF). The free amino groups were then stained with bromophenol blue. The blocking of the free N-terminal amino functions was carried out with a 2% acetic anhydride solution in DMF until the blue stain had disappeared. The membrane was then washed for a total of 3×10 min with 4×DMF and for 3 min each time 3× with ethanol. The membrane was then dried in the air. The individual spots were subsequently punched out and introduced into the wells (depressions) of two 96-well deep-well microtitre plates (2 ml per well) made of polypropylene. The diameter of the punched-out spots was 3.5 mm.

Step 2: Dispersion of the Polymeric Support with Retention of the Covalent Bond Between the Support and the Probe Molecule

300 μl of a TFA solution were applied to each individual spot (about 0.1 cm², 50 nmol of probe) . The deep-well microtitre plates were closed and treated with ultrasound for 10 min. The plates were then agitated for 1 hour. After a second 10 min of ultrasound treatment, the deep-well microtitre plates were agitated overnight at room temperature until all the spots had been completely dispersed. At the same time, that solution was used to remove the side chain protecting groups still present e on the peptide probes, so that only unprotected peptide was still present on the dispersed polymeric support material. The TFA solution contained 85% by vol. trifluoroacetic acid, 7% by vol. dichloromethane, 3% by vol. tri-isobutylsilane and 5% by vol. water. The total reaction time overnight was about 16 hours.

### Step 3: Precipitation and Purification of the Synthesised Compound

1 ml of diethyl ether was introduced into each individual well of the 96-well deep-well microtitre plate containing the spots dissolved in TFA solution in order to precipitate the dissolved polymeric support. The microtitre plates were then agitated for 10 min and subsequently left to stand in the refrigerator for 15 min at 4° C. Centrifugation at 3000 rev/min was then carried out for 6 min. The supernatant, which contained inter alia the protecting groups that had been removed, was carefully removed by pipette. The polymeric support having the probe molecules located thereon remained behind as residue in the wells of the microtitre plates. The residue was washed three times with ether. For that purpose, 1 ml of ether was first added to the precipitate in each well, the microtitre plates were agitated for 10 min and then centrifuged at 3000 rev/min for 10 min, and the supernatant solution was removed by pipette. After the last washing step, the microtitre plates were left to stand in the air to evaporate off ether residues.

### Step 4: Analytical Quality Control of the Probe Molecules

From the solution with TFA obtained in Step 2, a portion corresponding to 5 nmol of probe was removed and treated separately as described in Steps 2 and 3. The precipitated and dried residue was treated in a firmly closed Eppendorf test e tube with 20 μl of a 33% aqueous ammonia solution at 80° C. for 4 hours. The ester bond of the probe cellulose to the amide was thus cleaved, and the probe was detached from the cellulose support. 0.5 μl of that solution was then mixed with 0.5 μl of α-cinnamic acid and applied to a MALDI support. The probe and the synthesis by-products were identified by measurement of the molecular weight by means of Matrix-Assisted-Laser-Desorption Ionisation (MALDI) mass spectroscopy and thus the identity and purity of the synthesis product was determined.

### Step 5: Dissolution of the Polymeric Support

500 μl of DMSO were introduced into each individual well of the polypropylene deep-well microtitre plate containing the dried residues from Step 3 and treated with ultrasound for 10 min. The plate was then agitated overnight until the precipitated polymeric support having the probe molecule located thereon had completely dissolved. Small residues of the precipitate were separated off by centrifugation for 10 min at 3000 rev/min. 3 μl portions of the solutions so obtained were removed and in a 96-well standard microtitre plate each diluted with 57 μl of DMSO so that a 1:20 dilution was obtained. Those solutions were then used for the spotting.

Step 6: Production of the Microarray by Spotting the Solutions onto Planar Surfaces

The drops, 1-20 nl in size, of the 1:20 dilutions were applied to a planar surface using a microfeeder (MicroGrid II from BioRobotics; e.g. Gilson Model 231; GeSiM Nano-Plotter). Superfrost glass slides from Menzel, Braunschweig, Germany, 76×26 mm in size, cut edge. A grid of 25×5 points was spotted, corresponding to 125 spots. Because only 120 peptides were present, the last 5 spots in the array were spotted with e the original sequence Ac-NYGKYE for control purposes. 9 replicates of the 25×5 array were spotted onto each glass slide, a 64 pin tool having 1 split pin (about 1 nl transfer) being used for spotting. The spacing of the spots from one another was 0.5 mm. The spotted glass slides were dried for 2 hours at 50° C. and then stored at 4° C.

### Step 7: Antibody Test

The binding test with the 1D3 antibody was carried out in accordance with the method described by Frank and Overwin, 1996 (see above). The incubation with the 1D3 antibody and a second detection antibody was carried out by applying the antibody solution (60 μl of solution containing 10 μg/ml of 1D3 antibody) dropwise to the glass slide and then covering with a cover glass. The detection antibody used was the goat anti-mouse antibody described by Frank and Overwin, 1996 but which had been labelled with the fluorescent dye Cy5. The labelling was carried out in accordance with the directions of the manufacturer (Amersham Biosciences, product number PA25001). It was thereby possible to evaluate the microarray test using a fluorescence detector. The read-out of the fluorescent signals was carried out with an ArrayWorx Scanner from Applied Precision using the wavelength ranges for stimulation and emission wavelength preset for Cy5 labelling by the manufacturer.

Alternatively, it is also possible to use as detection antibody the conjugate with alkaline phosphatase mentioned by Frank and Overwin, 1996, so that detection by staining with MTT and BCIP is possible. Evaluation is then carried out in the usual way using a conventional scanner.

### List of Abbreviations Used

| | |
|---|---|
| DMF | dimethylformamide |
| NMP | N-methylpyrrolidone |
| DMSO | dimethyl sulfoxide |
| EtOH | ethanol |
| TFA | trifluoroacetic acid |
| TIBS | tri-isobutylsilane |
| DCM | dichloromethane |
| MTT | methyltiazolyldiphenyltetrazolium bromide |
| BCIP | bromo-chloro-indolyl phosphate |

### List of Synthesised Peptide Sequences

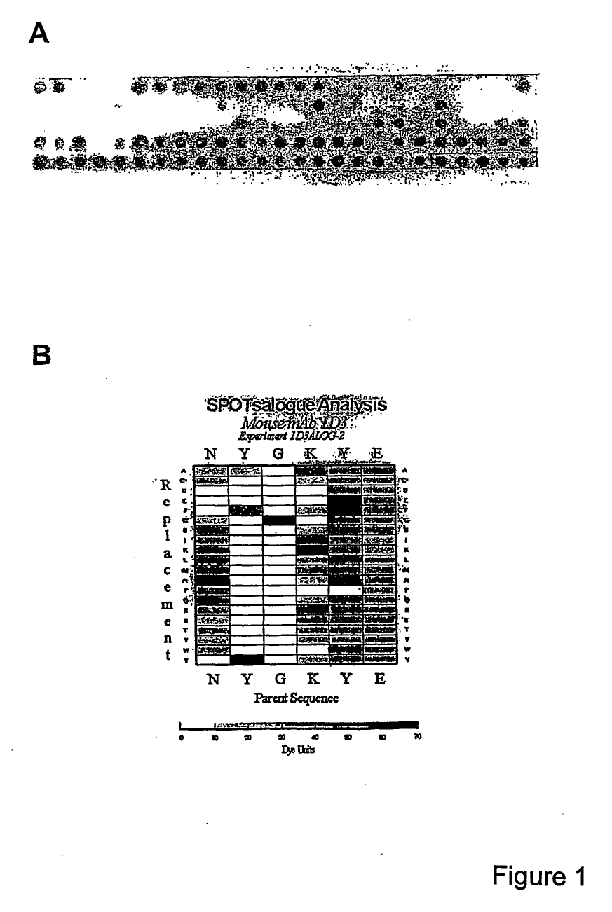

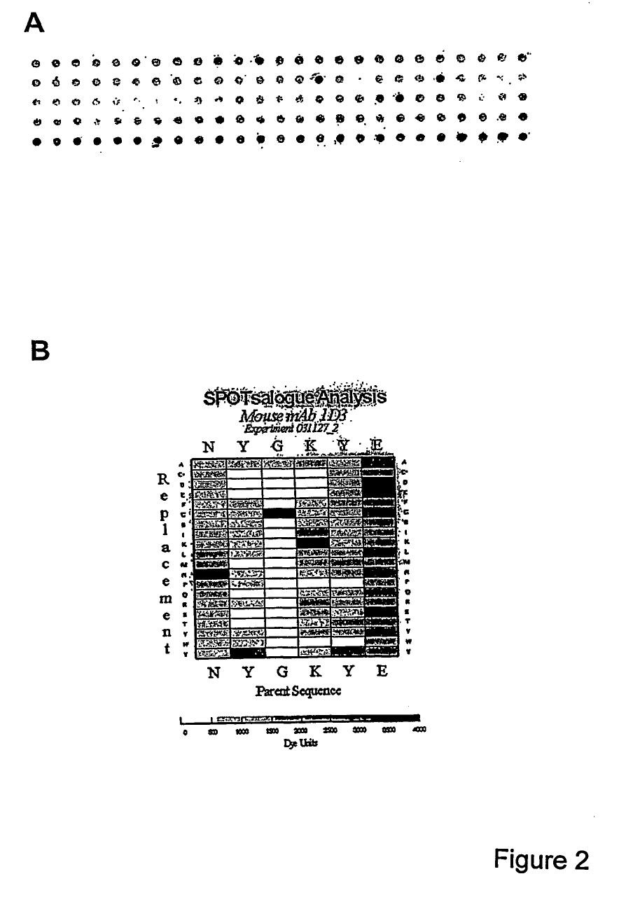

The position indicated relates to the position of the peptides in the array on the planar support/glass slide, as can be seen in FIGS. 1A and 2A.

| | | |
|---|---|---|
| Position | Peptide sequence | SEQ ID NO: |

| | | |
|---|---|---|
| A1 | AYGKYE | SEQ ID NO: 1 |
| A2 | CYGKYE | SEQ ID NO: 2 |
| A3 | DYGKYE | SEQ ID NO: 3 |
| A4 | EYGKYE | SEQ ID NO: 4 |
| A5 | FYGKYE | SEQ ID NO: 5 |
| A6 | GYGKYE | SEQ ID NO: 6 |
| A7 | HYGKYE | SEQ ID NO: 7 |
| A8 | IYGKYE | SEQ ID NO: 8 |
| A9 | KYGKYE | SEQ ID NO: 9 |
| A10 | LYGKYE | SEQ ID NO: 10 |
| A11 | MYGKYE | SEQ ID NO: 11 |
| A12 | NYGKYE | SEQ ID NO: 12 |
| A13 | PYGKYE | SEQ ID NO: 13 |
| A14 | QYGKYE | SEQ ID NO: 14 |
| A15 | RYGKYE | SEQ ID NO: 15 |
| A16 | SYGKYE | SEQ ID NO: 16 |
| A17 | TYGKYE | SEQ ID NO: 17 |
| A18 | VYGKYE | SEQ ID NO: 18 |
| A19 | WYGKYE | SEQ ID NO: 19 |
| A20 | YYGKYE | SEQ ID NO: 20 |
| A21 | NAGKYE | SEQ ID NO: 21 |
| A22 | NCGKYE | SEQ ID NO: 22 |
| A23 | NDGKYE | SEQ ID NO: 23 |
| A24 | NEGKYE | SEQ ID NO: 24 |
| A25 | NFGKYE | SEQ ID NO: 25 |
| B1 | NGGKYE | SEQ ID NO: 26 |
| B2 | NHGKYE | SEQ ID NO: 27 |
| B3 | NIGKYE | SEQ ID NO: 28 |
| B4 | NKGKYE | SEQ ID NO: 29 |
| B5 | NLGKYE | SEQ ID NO: 30 |
| B6 | NMGKYE | SEQ ID NO: 31 |
| B7 | NNGKYE | SEQ ID NO: 32 |
| B8 | NPGKYE | SEQ ID NO: 33 |
| B9 | NQGKYE | SEQ ID NO: 34 |
| B10 | NRGKYE | SEQ ID NO: 35 |
| B11 | NSGKYE | SEQ ID NO: 36 |
| B12 | NTGKYE | SEQ ID NO: 37 |
| B13 | NVGKYE | SEQ ID NO: 38 |
| B14 | NWGKYE | SEQ ID NO: 39 |
| B15 | NYGKYE | SEQ ID NO: 40 |
| B16 | NYAKYE | SEQ ID NO: 41 |
| B17 | NYCKYE | SEQ ID NO: 42 |
| B18 | NYDKYE | SEQ ID NO: 43 |
| B19 | NYEKYE | SEQ ID NO: 44 |
| B20 | NYFKYE | SEQ ID NO: 45 |
| B21 | NYGKYE | SEQ ID NO: 46 |
| B22 | NYHKYE | SEQ ID NO: 47 |
| B23 | NYIKYE | SEQ ID NO: 48 |
| B24 | NYKKYE | SEQ ID NO: 49 |
| B25 | NYLKYE | SEQ ID NO: 50 |
| C1 | NYMKYE | SEQ ID NO: 51 |
| C2 | NYNKYE | SEQ ID NO: 52 |
| C3 | NYPKYE | SEQ ID NO: 53 |
| C4 | NYQKYE | SEQ ID NO: 54 |
| C5 | NYRKYE | SEQ ID NO: 55 |
| C6 | NYSKYE | SEQ ID NO: 56 |
| C7 | NYTKYE | SEQ ID NO: 57 |
| C8 | NYVKYE | SEQ ID NO: 58 |
| C9 | NYWKYE | SEQ ID NO: 59 |
| C10 | NYYKYE | SEQ ID NO: 60 |
| C11 | NYGAYE | SEQ ID NO: 61 |
| C12 | NYGCYE | SEQ ID NO: 62 |
| C13 | NYGDYE | SEQ ID NO: 63 |
| C14 | NYGEYE | SEQ ID NO: 64 |
| C15 | NYGFYE | SEQ ID NO: 65 |
| C16 | NYGGYE | SEQ ID NO: 66 |
| C17 | NYGHYE | SEQ ID NO: 67 |
| C18 | NYGIYE | SEQ ID NO: 68 |
| C19 | NYGKYE | SEQ ID NO: 69 |
| C20 | NYGLYE | SEQ ID NO: 70 |
| C21 | NYGMYE | SEQ ID NO: 71 |
| C22 | NYGNYE | SEQ ID NO: 72 |
| C23 | NYGPYE | SEQ ID NO: 73 |
| C24 | NYGQYE | SEQ ID NO: 74 |
| C25 | NYGRYE | SEQ ID NO: 75 |
| D1 | NYGSYE | SEQ ID NO: 76 |
| D2 | NYGTYE | SEQ ID NO: 77 |
| D3 | NYGVYE | SEQ ID NO: 78 |
| D4 | NYGWYE | SEQ ID NO: 79 |
| D5 | NYGYYE | SEQ ID NO: 80 |
| D6 | NYGKAE | SEQ ID NO: 81 |
| D7 | NYGKCE | SEQ ID NO: 82 |
| D8 | NYGKDE | SEQ ID NO: 83 |
| D9 | NYCKEE | SEQ ID NO: 84 |
| D10 | NYGKFE | SEQ ID NO: 85 |
| D11 | NYGKGE | SEQ ID NO: 86 |
| D12 | NYGKHE | SEQ ID NO: 87 |
| D13 | NYGKIE | SEQ ID NO: 88 |
| D14 | NYGKKE | SEQ ID NO: 89 |
| D15 | NYGKLE | SEQ ID NO: 90 |
| D16 | NYGKME | SEQ ID NO: 91 |
| D17 | NYGKNE | SEQ ID NO: 92 |
| D18 | NYGKPE | SEQ ID NO: 93 |
| D19 | NYGKQE | SEQ ID NO: 94 |
| D20 | NYGKRE | SEQ ID NO: 95 |
| D21 | NYGKSE | SEQ ID NO: 96 |
| D22 | NYGKTE | SEQ ID NO: 97 |
| D23 | NYGKVE | SEQ ID NO: 98 |
| D24 | NYGKWE | SEQ ID NO: 99 |
| D25 | NYGKYE | SEQ ID NO: 100 |
| E1 | NYGKYA | SEQ ID NO: 101 |
| E2 | NYCKYC | SEQ ID NO: 102 |
| E3 | NYGKYD | SEQ ID NO: 103 |
| E4 | NYGKYE | SEQ ID NO: 104 |
| E5 | NYGKYF | SEQ ID NO: 105 |
| E6 | NYGKYG | SEQ ID NO: 106 |
| E7 | NYGKYH | SEQ ID NO: 107 |
| E8 | NYGKYI | SEQ ID NO: 108 |
| E9 | NYGKYK | SEQ ID NO: 109 |
| E10 | NYGKYL | SEQ ID NO: 110 |
| E11 | NYGKYM | SEQ ID NO: 111 |
| E12 | NYGKYN | SEQ ID NO: 112 |
| E13 | NYGKYP | SEQ ID NO: 113 |
| E14 | NYGKYQ | SEQ ID NO: 114 |
| E15 | NYGKYR | SEQ ID NO: 115 |
| E16 | NYGKYS | SEQ ID NO: 116 |
| E17 | NYGKYT | SEQ ID NO: 117 |
| E18 | NYGKYV | SEQ ID NO: 118 |
| E19 | NYCKYW | SEQ ID NO: 119 |
| E20 | NYGKYY | SEQ ID NO: 120 |
| E21 | NYGKYE | SEQ ID NO: 121 |
| E22 | NYGKYE | SEQ ID NO: 122 |
| E23 | NYGKYE | SEQ ID NO: 123 |
| E24 | NYGKYE | SEQ ID NO: 124 |
| E25 | NYGKYE | SEQ ID NO: 125 |

### LIST OF REFERENCES

1. Benoit et al., Anal. Chem. 73 (2001), 2412-2420
2. Bowtell and Sambrook, In: DNA Microarrays: A cloning manual. Cold Spring Harbor Laboratory Press, Cold Spring Harbor, N.Y., (2003), ISBN 0-87969-624-9
3. Dittrich et al., Bioorg. Med. Chem. Lett. 8 (1998), 2351-2356
4. Dörwald, In: Organic Synthesis on Solid Phase, (2000) Wiley-VCH Verlag GmbH, Weinheim, Germany, ISBN 3-527-29950-5
5. Erck et al., Neurochem. Res. 25 (2000), 5-10
6. Frank, J. Immunol. Meth. 267 (2002), 13-26
7. Frank, Nucleic Acids Res. 11 (1983), 4365-4377
8. Frank, Tetrahedron 48 (-1-992), 9217-9232
9. Frank and Doring, Tetrahedron 44, 19 (1988), 6031-6040
10. Frank and Overwin, In: Methods in Molecular Biology, 66:

Epitope Mapping Protocols (G. E. Morris, Ed.), The Humana Press Inc., Totowa, USA (1996), 149-169
11. Goddard et al., J. Chem. Soc. Chem. Commun. (1988), 1025-1027
12. Hansen et al., Int. J. Peptide Protein Res. 41 (1993), 237-245
13. Harlow and Lane, In: Antibodies: A laboratory manual. Cold Spring Harbor, N.Y., (1988)
14. Hoffmüller et al., Angew. Chem. Int. Ed. 38 (1999) 2000-2003
15. Sambrook et al., Molecular Cloning: A laboratory manual. Cold Spring Harbor, N.Y. (1989), ISBN 0-87969-309-6
16 Southern et al., Nature Genetics Suppl. No. 1 (1999), 5-9
17. The SPOT-Synthesis Technique: Synthetic Peptide Arrays on Membrane Supports. In: Methods of parallel peptide synthesis and their contributions to deciphering molecular interactions in the immune system. Guest Editor: C. Granier, Part 3, The SPOT method of peptide synthesis: the role of arrayed peptides in revealing key features of antigen-antibody recognition. Special Issue of the Journal of Immunological Methods
18. Wölfl in: Transcript Laborwelt 3 (2000), 13-20
19. Xu et al., Molecular Diversity (2004), 1-10
20. Yershov et al., PNAS 93 (1996), 4913-4918

1-17. (canceled)

18. A method of producing a microarray, comprising:
(a) synthesis, in two or more stages, of probe molecules on a polymeric support, bonds being formed between the probe molecules and the polymeric support;
(b) dispersion of the polymeric support having the synthetic probe molecules in accordance with step (a), the bonds between the polymeric support and the probe molecules being retained;
(c) dissolution of the polymeric support having the bound probe molecules; and
(d) application of the solution containing the polymeric support having the bound probe molecules in the form of microdrops to a planar surface.

19. The method of claim 18 wherein the probe molecules bound to the polymeric support are purified.

20. The method of claim 18 wherein the synthetic probe molecules are purified.

21. The method of claim 18 wherein the bonds between the probe molecules and the polymeric support are chemical bonds.

22. The method of claim 18 further comprising, following Step (a), a Step (a1):
(a1) pre-purification of the probe molecules by washing and optionally removal of protecting groups.

23. The method of claim 18 wherein the polymeric support in Step (b) is dispersed in a mixture of trifluoroacetic acid (TFA), dichloromethane, tri-isobutylsilane (TIBS) and water.

24. The method of claim 23 wherein the mixture contains about 60-100% by vol. trifluoroacetic acid, about 0-15% by vol. dichloromethane, about 0-15% by vol. tri-isobutylsilane, and about 0-5% by vol. water.

25. The method of claim 23 wherein the mixture contains about 80-90% by vol. trifluoroacetic acid, about 5-15% by vol. dichloromethane, about 2-5% by vol. tri-isobutylsilane, and about 2-5% by vol. water.

26. The method of claim 23 wherein the reaction time for dispersion of the polymeric support in Step (b) being about 0.1-24 hours.

27. The method of claim 23 wherein the compounds in Step (c) are washed 3 to 5 times in diethyl ether, acetone or tert-butylmethyl ether.

28. The method of claim 23 wherein polymeric support material having the bound probe molecules is dissolved in water, DMF, NMP or DMSO.

29. The method of claim 23 wherein the probe molecules are short-chain peptides, polypeptides, polysaccharides, nucleic acids, DNA molecules or RNA molecules, or small organic molecules.

30. The method of claim 23 wherein the planar surface in Step (e) is the surface of a microchip.

31. The method of claim 23 wherein the planar surface comprises of metal, glass, plastics material or ceramics.

32. The method of claim 23 wherein the polymeric support comprises protein, disulfide-crosslinked polyacrylate or paper.

33. The method of claim 23 wherein the polymeric support comprises cellulose paper.

34. A microarray obtainable by the method of claim 23 for detecting interactions between probe molecules and analyte molecules from a sample.

35. A method for detecting interactions between probe molecules and analyte molecules from a sample, comprising using a microarray of claim 34.

36. The method of claim 35 wherein analyte molecules are short-chain peptides, polypeptides, polysaccharides or nucleic acids, DNA molecules or RNA molecules, or small organic molecules.

37. The method of claim 35 wherein the sample is a human sample.


SEQUENCE LISTING (125 sequences)

SEQ ID NO: 1 - protein, 6 aa, Artificial Sequence
  Description of Artificial Sequence Synthetic peptide
AYGKYE

SEQ ID NO: 2 - protein, 6 aa, Artificial Sequence
  Description of Artificial Sequence Synthetic peptide
CYGKYE

SEQ ID NO: 3 - protein, 6 aa, Artificial Sequence
  Description of Artificial Sequence Synthetic peptide
DYGKYE

SEQ ID NO: 4 - protein, 6 aa, Artificial Sequence
  Description of Artificial Sequence Synthetic peptide
EYGKYE

SEQ ID NO: 5 - protein, 6 aa, Artificial Sequence
  Description of Artificial Sequence Synthetic peptide
FYGKYE

SEQ ID NO: 6 - protein, 6 aa, Artificial Sequence
  Description of Artificial Sequence Synthetic peptide
GYGKYE

SEQ ID NO: 7 - protein, 6 aa, Artificial Sequence
  Description of Artificial Sequence Synthetic peptide
HYGKYE

SEQ ID NO: 8 - protein, 6 aa, Artificial Sequence
  Description of Artificial Sequence Synthetic peptide
IYGKYE

SEQ ID NO: 9 - protein, 6 aa, Artificial Sequence
  Description of Artificial Sequence Synthetic peptide
KYGKYE

SEQ ID NO: 10 - protein, 6 aa, Artificial Sequence
  Description of Artificial Sequence Synthetic peptide
LYGKYE

SEQ ID NO: 11 - protein, 6 aa, Artificial Sequence
  Description of Artificial Sequence Synthetic peptide
MYGKYE

SEQ ID NO: 12 - protein, 6 aa, Artificial Sequence
  Description of Artificial Sequence Synthetic peptide
NYGKYE

SEQ ID NO: 13 - protein, 6 aa, Artificial Sequence
  Description of Artificial Sequence Synthetic peptide
PYGKYE

SEQ ID NO: 14 - protein, 6 aa, Artificial Sequence
  Description of Artificial Sequence Synthetic peptide
QYGKYE

SEQ ID NO: 15 - protein, 6 aa, Artificial Sequence
  Description of Artificial Sequence Synthetic peptide
RYGKYE

SEQ ID NO: 16 - protein, 6 aa, Artificial Sequence
  Description of Artificial Sequence Synthetic peptide
SYGKYE

SEQ ID NO: 17 - protein, 6 aa, Artificial Sequence
  Description of Artificial Sequence Synthetic peptide
TYGKYE

SEQ ID NO: 18 - protein, 6 aa, Artificial Sequence
  Description of Artificial Sequence Synthetic peptide
VYGKYE

SEQ ID NO: 19 - protein, 6 aa, Artificial Sequence
  Description of Artificial Sequence Synthetic peptide
WYGKYE

SEQ ID NO: 20 - protein, 6 aa, Artificial Sequence
  Description of Artificial Sequence Synthetic peptide
YYGKYE

SEQ ID NO: 21 - protein, 6 aa, Artificial Sequence
  Description of Artificial Sequence Synthetic peptide
NAGKYE

SEQ ID NO: 22 - protein, 6 aa, Artificial Sequence
  Description of Artificial Sequence Synthetic peptide
NCGKYE

SEQ ID NO: 23 - protein, 6 aa, Artificial Sequence
  Description of Artificial Sequence Synthetic peptide
NDGKYE

SEQ ID NO: 24 - protein, 6 aa, Artificial Sequence
  Description of Artificial Sequence Synthetic peptide
NEGKYE

SEQ ID NO: 25 - protein, 6 aa, Artificial Sequence
  Description of Artificial Sequence Synthetic peptide
NFGKYE

SEQ ID NO: 26 - protein, 6 aa, Artificial Sequence
  Description of Artificial Sequence Synthetic peptide
NGGKYE

SEQ ID NO: 27 - protein, 6 aa, Artificial Sequence
  Description of Artificial Sequence Synthetic peptide
NHGKYE

SEQ ID NO: 28 - protein, 6 aa, Artificial Sequence
  Description of Artificial Sequence Synthetic peptide
NIGKYE

SEQ ID NO: 29 - protein, 6 aa, Artificial Sequence
  Description of Artificial Sequence Synthetic peptide
NKGKYE

SEQ ID NO: 30 - protein, 6 aa, Artificial Sequence
  Description of Artificial Sequence Synthetic peptide
NLGKYE

SEQ ID NO: 31 - protein, 6 aa, Artificial Sequence
  Description of Artificial Sequence Synthetic peptide
NMGKYE

SEQ ID NO: 32 - protein, 6 aa, Artificial Sequence
  Description of Artificial Sequence Synthetic peptide
NNGKYE

SEQ ID NO: 33 - protein, 6 aa, Artificial Sequence
  Description of Artificial Sequence Synthetic peptide
NPGKYE

SEQ ID NO: 34 - protein, 6 aa, Artificial Sequence
  Description of Artificial Sequence Synthetic peptide
NQGKYE

SEQ ID NO: 35 - protein, 6 aa, Artificial Sequence
  Description of Artificial Sequence Synthetic peptide
NRGKYE

SEQ ID NO: 36 - protein, 6 aa, Artificial Sequence
  Description of Artificial Sequence Synthetic peptide
NSGKYE

SEQ ID NO: 37 - protein, 6 aa, Artificial Sequence
  Description of Artificial Sequence Synthetic peptide
NTGKYE

SEQ ID NO: 38 - protein, 6 aa, Artificial Sequence
  Description of Artificial Sequence Synthetic peptide
NVGKYE

SEQ ID NO: 39 - protein, 6 aa, Artificial Sequence
  Description of Artificial Sequence Synthetic peptide
NWGKYE

SEQ ID NO: 40 - protein, 6 aa, Artificial Sequence
  Description of Artificial Sequence Synthetic peptide
NYGKYE

SEQ ID NO: 41 - protein, 6 aa, Artificial Sequence
  Description of Artificial Sequence Synthetic peptide
NYAKYE

SEQ ID NO: 42 - protein, 6 aa, Artificial Sequence
  Description of Artificial Sequence Synthetic peptide
NYCKYE

SEQ ID NO: 43 - protein, 6 aa, Artificial Sequence
  Description of Artificial Sequence Synthetic peptide
NYDKYE

SEQ ID NO: 44 - protein, 6 aa, Artificial Sequence
  Description of Artificial Sequence Synthetic peptide
NYEKYE

SEQ ID NO: 45 - protein, 6 aa, Artificial Sequence
  Description of Artificial Sequence Synthetic peptide
NYFKYE

SEQ ID NO: 46 - protein, 6 aa, Artificial Sequence
  Description of Artificial Sequence Synthetic peptide
NYGKYE

SEQ ID NO: 47 - protein, 6 aa, Artificial Sequence
  Description of Artificial Sequence Synthetic peptide
NYHKYE

SEQ ID NO: 48 - protein, 6 aa, Artificial Sequence
  Description of Artificial Sequence Synthetic peptide
NYIKYE

SEQ ID NO: 49 - protein, 6 aa, Artificial Sequence
  Description of Artificial Sequence Synthetic peptide
NYKKYE

SEQ ID NO: 50 - protein, 6 aa, Artificial Sequence
  Description of Artificial Sequence Synthetic peptide
NYLKYE

SEQ ID NO: 51 - protein, 6 aa, Artificial Sequence
  Description of Artificial Sequence Synthetic peptide
NYMKYE

SEQ ID NO: 52 - protein, 6 aa, Artificial Sequence
  Description of Artificial Sequence Synthetic peptide
NYNKYE

SEQ ID NO: 53 - protein, 6 aa, Artificial Sequence
  Description of Artificial Sequence Synthetic peptide
NYPKYE

SEQ ID NO: 54 - protein, 6 aa, Artificial Sequence
  Description of Artificial Sequence Synthetic peptide
NYQKYE

SEQ ID NO: 55 - protein, 6 aa, Artificial Sequence
  Description of Artificial Sequence Synthetic peptide
NYRKYE

SEQ ID NO: 56 - protein, 6 aa, Artificial Sequence
  Description of Artificial Sequence Synthetic peptide
NYSKYE

SEQ ID NO: 57 - protein, 6 aa, Artificial Sequence
  Description of Artificial Sequence Synthetic peptide
NYTKYE

SEQ ID NO: 58 - protein, 6 aa, Artificial Sequence
  Description of Artificial Sequence Synthetic peptide
NYVKYE

SEQ ID NO: 59 - protein, 6 aa, Artificial Sequence
  Description of Artificial Sequence Synthetic peptide
NYWKYE

SEQ ID NO: 60 - protein, 6 aa, Artificial Sequence
  Description of Artificial Sequence Synthetic peptide
NYYKYE

SEQ ID NO: 61 - protein, 6 aa, Artificial Sequence
  Description of Artificial Sequence Synthetic peptide
NYGAYE

SEQ ID NO: 62 - protein, 6 aa, Artificial Sequence
  Description of Artificial Sequence Synthetic peptide
NYGCYE

SEQ ID NO: 63 - protein, 6 aa, Artificial Sequence
  Description of Artificial Sequence Synthetic peptide
NYGDYE

SEQ ID NO: 64 - protein, 6 aa, Artificial Sequence
  Description of Artificial Sequence Synthetic peptide
NYGEYE

SEQ ID NO: 65 - protein, 6 aa, Artificial Sequence
  Description of Artificial Sequence Synthetic peptide
NYGFYE

SEQ ID NO: 66 - protein, 6 aa, Artificial Sequence
  Description of Artificial Sequence Synthetic peptide
NYGGYE

SEQ ID NO: 67 - protein, 6 aa, Artificial Sequence
  Description of Artificial Sequence Synthetic peptide
NYGHYE

SEQ ID NO: 68 - protein, 6 aa, Artificial Sequence
  Description of Artificial Sequence Synthetic peptide
NYGIYE

SEQ ID NO: 69 - protein, 6 aa, Artificial Sequence
  Description of Artificial Sequence Synthetic peptide
NYGKYE

SEQ ID NO: 70 - protein, 6 aa, Artificial Sequence
  Description of Artificial Sequence Synthetic peptide
NYGLYE

SEQ ID NO: 71 - protein, 6 aa, Artificial Sequence
  Description of Artificial Sequence Synthetic peptide
NYGMYE

SEQ ID NO: 72 - protein, 6 aa, Artificial Sequence
  Description of Artificial Sequence Synthetic peptide
NYGNYE

SEQ ID NO: 73 - protein, 6 aa, Artificial Sequence
  Description of Artificial Sequence Synthetic peptide
NYGPYE

SEQ ID NO: 74 - protein, 6 aa, Artificial Sequence
  Description of Artificial Sequence Synthetic peptide
NYGQYE

SEQ ID NO: 75 - protein, 6 aa, Artificial Sequence
  Description of Artificial Sequence Synthetic peptide
NYGRYE

SEQ ID NO: 76 - protein, 6 aa, Artificial Sequence
  Description of Artificial Sequence Synthetic peptide
NYGSYE

SEQ ID NO: 77 - protein, 6 aa, Artificial Sequence
  Description of Artificial Sequence Synthetic peptide
NYGTYE

SEQ ID NO: 78 - protein, 6 aa, Artificial Sequence
  Description of Artificial Sequence Synthetic peptide
NYGVYE

SEQ ID NO: 79 - protein, 6 aa, Artificial Sequence
  Description of Artificial Sequence Synthetic peptide
NYGWYE

SEQ ID NO: 80 - protein, 6 aa, Artificial Sequence
  Description of Artificial Sequence Synthetic peptide
NYGYYE

SEQ ID NO: 81 - protein, 6 aa, Artificial Sequence
  Description of Artificial Sequence Synthetic peptide
NYGKAE

SEQ ID NO: 82 - protein, 6 aa, Artificial Sequence
  Description of Artificial Sequence Synthetic peptide
NYGKCE

SEQ ID NO: 83 - protein, 6 aa, Artificial Sequence
  Description of Artificial Sequence Synthetic peptide
NYGKDE

SEQ ID NO: 84 - protein, 6 aa, Artificial Sequence
  Description of Artificial Sequence Synthetic peptide
NYGKEE

SEQ ID NO: 85 - protein, 6 aa, Artificial Sequence
  Description of Artificial Sequence Synthetic peptide
NYGKFE

SEQ ID NO: 86 - protein, 6 aa, Artificial Sequence
  Description of Artificial Sequence Synthetic peptide
NYGKGE

SEQ ID NO: 87 - protein, 6 aa, Artificial Sequence
  Description of Artificial Sequence Synthetic peptide
NYGKHE

SEQ ID NO: 88 - protein, 6 aa, Artificial Sequence
  Description of Artificial Sequence Synthetic peptide
NYGKIE

SEQ ID NO: 89 - protein, 6 aa, Artificial Sequence
  Description of Artificial Sequence Synthetic peptide
NYGKKE

SEQ ID NO: 90 - protein, 6 aa, Artificial Sequence
  Description of Artificial Sequence Synthetic peptide
NYGKLE

SEQ ID NO: 91 - protein, 6 aa, Artificial Sequence
  Description of Artificial Sequence Synthetic peptide
NYGKME

SEQ ID NO: 92 - protein, 6 aa, Artificial Sequence
  Description of Artificial Sequence Synthetic peptide
NYGKNE

SEQ ID NO: 93 - protein, 6 aa, Artificial Sequence
  Description of Artificial Sequence Synthetic peptide
NYGKPE

SEQ ID NO: 94 - protein, 6 aa, Artificial Sequence
  Description of Artificial Sequence Synthetic peptide
NYGKQE

SEQ ID NO: 95 - protein, 6 aa, Artificial Sequence
  Description of Artificial Sequence Synthetic peptide
NYGKRE

SEQ ID NO: 96 - protein, 6 aa, Artificial Sequence
  Description of Artificial Sequence Synthetic peptide
NYGKSE

SEQ ID NO: 97 - protein, 6 aa, Artificial Sequence
  Description of Artificial Sequence Synthetic peptide
NYGKTE

SEQ ID NO: 98 - protein, 6 aa, Artificial Sequence
  Description of Artificial Sequence Synthetic peptide
NYGKVE

SEQ ID NO: 99 - protein, 6 aa, Artificial Sequence
  Description of Artificial Sequence Synthetic peptide
NYGKWE

SEQ ID NO: 100 - protein, 6 aa, Artificial Sequence
  Description of Artificial Sequence Synthetic peptide
NYGKYE

SEQ ID NO: 101 - protein, 6 aa, Artificial Sequence
  Description of Artificial Sequence Synthetic peptide
NYGKYA

SEQ ID NO: 102 - protein, 6 aa, Artificial Sequence
  Description of Artificial Sequence Synthetic peptide
NYGKYC

SEQ ID NO: 103 - protein, 6 aa, Artificial Sequence
  Description of Artificial Sequence Synthetic peptide
NYGKYD

SEQ ID NO: 104 - protein, 6 aa, Artificial Sequence
  Description of Artificial Sequence Synthetic peptide
NYGKYE

SEQ ID NO: 105 - protein, 6 aa, Artificial Sequence
  Description of Artificial Sequence Synthetic peptide
NYGKYF

SEQ ID NO: 106 - protein, 6 aa, Artificial Sequence
  Description of Artificial Sequence Synthetic peptide
NYGKYG

SEQ ID NO: 107 - protein, 6 aa, Artificial Sequence
  Description of Artificial Sequence Synthetic peptide
NYGKYH

SEQ ID NO: 108 - protein, 6 aa, Artificial Sequence
  Description of Artificial Sequence Synthetic peptide
NYGKYI

SEQ ID NO: 109 - protein, 6 aa, Artificial Sequence
  Description of Artificial Sequence Synthetic peptide
NYGKYK

SEQ ID NO: 110 - protein, 6 aa, Artificial Sequence
  Description of Artificial Sequence Synthetic peptide
NYGKYL

SEQ ID NO: 111 - protein, 6 aa, Artificial Sequence
  Description of Artificial Sequence Synthetic peptide
NYGKYM

SEQ ID NO: 112 - protein, 6 aa, Artificial Sequence
  Description of Artificial Sequence Synthetic peptide
NYGKYN

SEQ ID NO: 113 - protein, 6 aa, Artificial Sequence
  Description of Artificial Sequence Synthetic peptide
NYGKYP

SEQ ID NO: 114 - protein, 6 aa, Artificial Sequence
  Description of Artificial Sequence Synthetic peptide
NYGKYQ

SEQ ID NO: 115 - protein, 6 aa, Artificial Sequence
  Description of Artificial Sequence Synthetic peptide
NYGKYR

SEQ ID NO: 116 - protein, 6 aa, Artificial Sequence
  Description of Artificial Sequence Synthetic peptide
NYGKYS

SEQ ID NO: 117 - protein, 6 aa, Artificial Sequence
  Description of Artificial Sequence Synthetic peptide
NYGKYT

SEQ ID NO: 118 - protein, 6 aa, Artificial Sequence
  Description of Artificial Sequence Synthetic peptide
NYGKYV

SEQ ID NO: 119 - protein, 6 aa, Artificial Sequence
  Description of Artificial Sequence Synthetic peptide
NYGKYW

SEQ ID NO: 120 - protein, 6 aa, Artificial Sequence
  Description of Artificial Sequence Synthetic peptide
NYGKYY

SEQ ID NO: 121 - protein, 6 aa, Artificial Sequence
  Description of Artificial Sequence Synthetic peptide
NYGKYE

SEQ ID NO: 122 - protein, 6 aa, Artificial Sequence
  Description of Artificial Sequence Synthetic peptide
NYGKYE

SEQ ID NO: 123 - protein, 6 aa, Artificial Sequence
  Description of Artificial Sequence Synthetic peptide
NYGKYE

SEQ ID NO: 124 - protein, 6 aa, Artificial Sequence
  Description of Artificial Sequence Synthetic peptide
NYGKYE

SEQ ID NO: 125 - protein, 6 aa, Artificial Sequence
  Description of Artificial Sequence Synthetic peptide
NYGKYE